(19) United States
(12) Patent Application Publication
(10) Pub. No.: US 2009/0000408 A1
(43) Pub. Date: Jan. 1, 2009

(54) Driving Mechanism

(76) Inventor: Bela Nadas, Budapest (HU)

Correspondence Address: Joseph G. Seeber, P.O.Box 750, Great Falls, VA, 22066, US

(21) Appl. No.: 10/594,141

(22) PCT Filed: Mar. 24, 2005
(86) PCT No.: PCT/HU2005/000031

§ 371 Date: Sep. 25, 2006

(30) Foreign Application Priority Data
Mar. 25, 2004 (HU) U 0400076

(51) Int. Cl. F16H 21/48

(52) U.S. Cl. 74/63

(57) ABSTRACT

The coupling gear (30) has a first torque transfer shaft (32) and a second torque transfer shaft (33) embedded in a house (31) in a rotating way, the input end (32b) of the first torque transfer shaft (32) is connected to the intermediate connecting piece (13b) of the first motion transfer unit (13) of the first connecting part-unit (10), and its output end (32c) is connected to the intermediate connecting piece (23b) of the first motion transfer unit (23) of the second connecting part-unit (20) while the input end (33b) of the second torque transfer shaft (33) is connected to the motion piece (14) of the first motion transfer unit (13) of the first connecting part-unit (10), and its output end (32c) is connected to the motion piece (14) of the first motion transfer unit (23) of the second connecting part-unit (20).

The subject of the invention relates to a driving mechanism for transferring torque from a driving shaft to a driven shaft, which consists of a first connecting part-unit attached to the driving shaft and a second connection part-unit attached to the driven shaft, and a coupling gear inserted between the first connecting part-unit and the second connecting part-unit.

Several solutions are known for transferring torque between driving and driven shafts by maintaining a constant angular speed. In the case of drive structures where the driving shaft and the driven shaft are parallel to each other or are at a certain angle with respect to each other, or maybe at a skew angle, different types of angle drive, mainly geared drive have been widely used. Such geared angle drive is described, for example, in patent specifications No. HU 208.653. and patent application No. HU P 98 02829.

The advantage of the known geared drives is that in the case of the driving shaft's constant rotational speed the angular speed of the driven shaft is also constant; at the same time its disadvantage is due to its complicated structural construction it can realise torque transfer exclusively in one angular position.

The significant cost of manufacturing gearwheels is also one of the disadvantages.

A further disadvantage is that in the case of each different arrangement of driving and driven shafts a unique gear drive needs to be manufactured, which increases the costs of realisation even more due to the lack of the possibility of the standardisation of types.

Angle drives equipped with cardan joints or a cardan shaft make angle drive possible at a greater degree of freedom, the advantage of which is that unlike geared angle drives they can be used in the case of greater angle errors too. Such solutions are described, for example, in patent specifications No. HU 204.115. and No. HU 201.706.

However, the disadvantage of these solutions is that due to the construction and coupling of the parts communicating with each other in the course of torque transfer the angle speed of the driven shaft continuously changes within wide limits, which in many cases cannot be allowed, so the construction can only be used successfully in the case of less demanding drive chains.

With the solution according to the invention our aim was to create a driving mechanism overcoming the deficiencies of the known angle drives, which can be easily assembled from simple structure elements, and the construction of which makes safe torque transfer possible while maintaining a constant angle speed between driving and driven shafts in an optional position.

The construction according to the invention is based on the recognition that if with the help of suitably chosen mechanisms the rotational motion of the driving shaft is divided into two motion components where the individual motion components transform the rotational motion of the driving shaft corresponding to each other, and the motion components transformed in this way are transferred to the driven shaft with the help of specifically arranged shafts and mechanisms connected to the shafts on the side of the driven shaft, then the torque can be transferred from the driving shaft to the driven shaft while maintaining a constant rotational speed, and so the task can be solved.

In accordance with the set aim the driving mechanism according to the invention for transferring torque from a driving shaft to a driven shaft, —which consists of a first connecting part-unit attached to the driving shaft and a second connection part-unit attached to the driven shaft, and a coupling gear inserted between the first connecting part-unit and the second connecting part-unit, —is constructed in a way that the first connecting part-unit contains an output member attached to the driving shaft in a fixed position, a first motion transfer unit connected to the output member via a one-degree-of-freedom connecting element and a motion piece connected to the first motion transfer unit in a rotating way, where there is an intermediate connecting piece between the one end of the first motion transfer unit connected to the output member and its other end connected to the motion piece, and the section between the one end of the first motion transfer unit and the intermediate connecting piece, and the section between the other end of the first motion transfer unit and the intermediate connecting piece are at an angle of 0-180° with respect to each other, —while the second connecting part-unit contains an input member attached to the driven shaft in a fixed position, a first motion transfer unit attached to the input member via a one-degree-of-freedom connecting element and a motion piece connected to the first motion transfer unit in a rotating way, where there is an intermediate connecting piece between the one end of the first motion transfer unit connected to the input member and its other end connected to the motion piece, and the section between the one end of the first motion transfer unit and the intermediate connecting piece, and the section between the other end of the first motion transfer unit and the intermediate connecting piece are at an angle of 0-180° with respect to each other, the coupling gear has a first torque transfer shaft and a second torque transfer shaft embedded in a house in a rotating way, the first torque transfer shaft has an input end and an output end, while the second torque transfer shaft has an input end and an output end, the input end of the first torque transfer shaft is connected to the intermediate connecting piece of the first motion transfer unit of the first connecting part-unit, and its output end is connected to the intermediate connecting piece of the first motion transfer unit of the second connecting part-unit allowing torque transfer, but in a self-adjusting way, while the input end of the second torque transfer shaft is connected to the motion piece of the first motion transfer unit of the first connecting part-unit, and its output end is connected to the motion piece of the first motion transfer unit of the second connecting part-unit allowing torque transfer, but in a self-adjusting way.

A further criterion of the driving mechanism according to the invention may be that the size and shape of the output member, the first motion transfer unit and the motion piece of the first connecting part-unit is the same as the size and shape of the input member, the first motion transfer unit and the motion piece of the second connecting part-unit, or they are in proportion with them at the same extent.

In the case of a different version of the driving mechanism the one-degree-of-freedom connecting element belonging to the first connecting part-unit is an element, practically a bearing, allowing the rotation of the first motion transfer unit around its own main axis in relation to the output member, and the one-degree-of-freedom connecting element belonging to the second connecting part-unit is an element, practically a bearing, allowing the rotation of the first motion transfer unit around its own main axis in relation to the input member.

In the case of a further different construction of the invention the axes of rotation of the first torque transfer shaft and the second torque transfer shaft are parallel to each other. The house has a fixed house-member and a swinging house-member, the fixed house-member is in a fixed position, and either the first torque transfer shaft or the second torque transfer shaft is fitted in the fixed house-member in a rotating way, while the other one of the first torque transfer shaft or the second torque transfer shaft is fitted in the other house-member in a rotating way, and the swinging house-member is attached in a fixed position to either one of the first torque transfer shaft or the second torque transfer shaft that is situated in the fixed house-member. The straight line touching the input end of the first torque transfer shaft and the input end of the second torque transfer shaft and the straight line touching the output end of the first torque transfer shaft and the output end of the second torque transfer shaft run parallel to each other.

In the case of an even further realisation of the driving mechanism the axis of rotation of the first torque transfer shaft and the axis of rotation of the second torque transfer shaft are parallel to each other.

The most important advantage of the driving mechanism according to the invention is that due to its structure, which is completely different from the known structures, torque transfer of a high angle-speed accuracy, free from gears can be realised, which is simple to use not only in the case of shafts positioned at a certain angle with respect to each other, but also in the case of parallel shafts.

It is also an advantage that the drive elements taking part in torque transfer are connected to each other by inserting bearings, which simplifies the operation of moving components, as in the drive chain there are no structural elements exposed to direct friction. As opposed to the additional lubrication required for cog-connections that are necessary in the case of geared drives, in the case of the construction according to the invention practically there are self-lubricating bearings at the connection of the components moving with respect to each other. Due to the fact that additional lubrication becomes unnecessary the construction of the structure becomes simpler, which also reduces its manufacturing costs.

It must also be regarded favourable that the structural elements of the driving mechanism according to the invention can be manufactured using traditional and simple technological procedures, at a favourable price, no special skills are needed for assembling the components, and the maintenance of the assembled structure is much simpler than that of a geared drive. In the course of using the construction according to the invention both manufacturing and operating costs may be more favourable.

A further advantage deriving from the novel construction of the driving mechanism is that due to the connections realised with bearings connections involving direct friction requiring additional lubrication are completely eliminated, which results in the omission of the often unstable additional lubricating system, which is liable to failures, improving by this the reliability of the driving mechanism and extending the life of the components.

It is also an advantage that a significant part of the structural elements of the driving mechanism according to the invention can be standardised as a result of which the same components can be used in the course of different applications, which may decrease the costs of installation even further and facilitate the wide use of the construction.

Below the driving mechanism according to the invention is described in detail in connection with construction examples, on the basis of a drawing. In the drawing

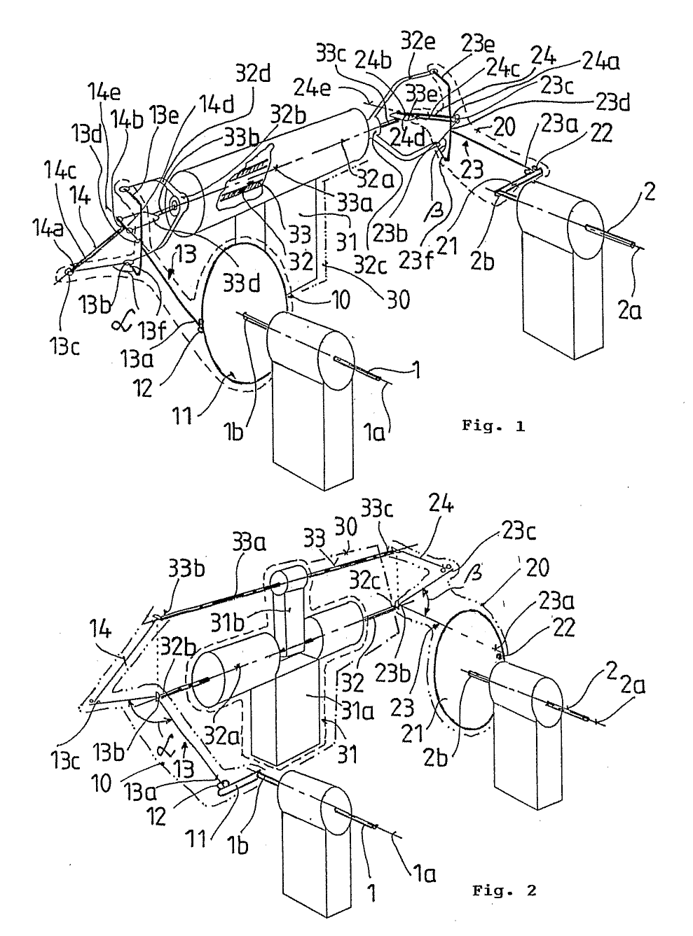

FIG. 1 is the plan view of a possible version of the driving mechanism,

FIG. 2 is the plan view of a different realisation of the driving mechanism.

FIG. 1 shows a construction of the driving mechanism, where the longitudinal axis 1a of the driving shaft 1 and the longitudinal axis 2a of the driven shaft 2 are parallel to each other. Between the end 1b of the driving shaft 1 and the end 2b of the driven shaft 2 there is the drive chain constructed of the first connecting part-unit 10, the coupling gear 30 and the second connecting part-unit 20.

The first connecting part-unit 10 contains the output member 11 attached to the end 1b of the driving shaft 1 in a fixed position, which output member 11 in the present case is a metal disc. On the output member 11 there is a one-degree-of-freedom connecting element 12, which is practically a suitable chosen ball-bearing, and its task is to accommodate the one end 13a of the first motion transfer unit 13 in a way that with the help of the one-degree-of-freedom connecting element 12 the first motion transfer unit 13 and the output member 11 can rotate with respect to each other. Apart from its one end 13a the first motion transfer unit 13 also has another end 13c and an intermediate connection piece 13b between the two ends.

Practically the first motion transfer unit 13 can be a component of an optional shape, but it is an essential requirement that the straight line touching the one end 13a and the intermediate connecting piece 13b and the straight line touching the other end 13c and the intermediate connecting piece 13b are at an “a” angle of 0-180° with respect to each other. In the present case this “α” angle is approximately a right angle. As a result of the construction on the part of the first motion transfer unit 13 between its one end 13a and the intermediate connecting piece 13b there is a fork 13d, which has a first arm 13e and a second arm 13f.

The intermediate connecting piece 13b is situated at the second arm 13f of the fork 13d of the first motion transfer piece 13, while the first motion transfer piece 13 has a further straight rod element running between the intermediate connecting piece 13b and the other end 13c. It is important that the second arm 13f of the fork 13d and its part between the intermediate connecting piece 13b and the other end 13c are situated at a fixed angle with respect to each other.

The motion piece 14 also belongs to the first connecting part-unit 10, and its external end 14a is a rod element connected to the other end 13c of the first motion transfer unit 13 via a ball bearing in this case. The external end 14a of the motion piece 14 is connected to the other end 13c of the first motion transfer unit 13 in a way that the first motion transfer unit 13 and the motion piece 14 can rotate with respect to each other around the axis 14c of the motion piece 14.

The next element of the drive chain is the coupling gear 30, which in the case of this construction contains a tubular first torque transfer shaft 32 embedded in the house 31 in a rotating way and the second torque transfer shaft 33 embedded in the first torque transfer shaft 32 also in a rotating way. Between the house 31 and the first torque transfer shaft 32, and between the first torque transfer shaft 32 and the second torque transfer shaft 33 self-lubricating ball-bearings or roller-bearings are inserted, so the first torque transfer shaft 32 and the second torque transfer shaft 33 can rotate around their own axes of rotation 32a and 33a with a low coefficient of friction. As a result of the construction it is evident that the axis of rotation 32a of the first torque transfer shaft 32 and the axis of rotation 33a of the other torque transfer shaft 33 are coaxial with respect to each other.

FIG. 1 also shows that there is a prong 32d at the input end 32b of the first torque transfer shaft 32, and the fork 13d of the first motion transfer unit 13 of the first connecting part-unit 10 is connected to this prong 32d. The degree of freedom of the connection between the prong 32d and the fork 13d allows the first motion transfer unit 13 to tilt with respect to the first torque transfer shaft 32.

At the input end 33b of the second torque transfer shaft 33 situated on the side of the first connecting part-unit 10 there is another prong 33d, and a cross-pin 14d situated on the internal end 14b of the motion piece 14 of the first connecting part-unit 10 is connected to this prong 33d. The connection between the prong 33d of the second torque transfer shaft 33 and the internal end 14b of the motion piece 14 is an ordinary one-degree-of-freedom pin-sleeve connection, where the motion piece 14 can tilt only in one direction, around the longitudinal axis 14e of the cross-pin 14d, with respect to the ends of the prong 33d.

At the other end of the coupling gear opposite the first connecting part-unit 10 there is the second connecting part-unit 20, which creates connection suitable for torque transfer between the first torque transfer shaft 32 and the second torque transfer shaft 33 of the coupling gear 30 and the end 2b of the driven shaft 2. The second connecting part-unit 20 has similar components to the structural elements of the first connecting part-unit 10. In accordance with this the second connecting part-unit 20 also contains an input member 21 attached to the end 2b of the driven shaft 2, a one-degree-of-freedom connecting element 22, practically a ball-bearing, situated at the end of the input member 21 opposite the end 2b of the driven shaft, a first motion transfer unit 23 connected to the one-degree-of-freedom connecting element 22 via its one end 23a, and a motion piece 24 connected to the first motion transfer unit 23 through its other end 23c.

FIG. 1 also shows that the size and shape of the first motion transfer unit 23 and motion piece 24 of the second connecting part-unit 20 is the same as the size and shape of the same components of the first connecting part-unit 10. The intermediate connecting piece 23b is situated between the first end 23a and the second end 23c of the first motion transfer unit 23. The part connecting the one end 23a with the intermediate connecting piece 23b and the part between the intermediate connecting piece 23b and the other end 23c delimit inclination angle “P”, which is also an angle between 0-180°, favourably approximately a right angle. The first motion transfer unit 23 also has a fork 23d, which has a first arm 23e and a second arm 23f. Furthermore the first motion transfer unit 23 and the output end 32c of the first torque transfer shaft 32, and the motion piece 24 and the output end 33c of the second torque transfer shaft 33 are also connected in a similar way as described regarding the connection of the first connecting part-unit 10 and the coupling gear 30. There is a prong 32e at the output end 32c of the first torque transfer shaft 32 too, which is connected to the one arm 23e and the second arm 23f of the fork 23d of the first motion transfer unit 23 in a way that they can rotate with respect to each other around the axis of connection.

The situation is similar regarding the connection between the motion piece 24 and the output end 33c of the second torque transfer shaft 33. In this case there is a cross-pin 24d at the internal end 24b of the first motion transfer unit 23 opposite the external end 24a connected to its other end 23c, which cross-pin 24d is connected to the prong 33e of the output end 33c of the second torque transfer shaft 33 in a way that the motion piece 24 can tilt around the longitudinal axis 24e of the cross-pin 24d.

The identical nature of the connection between the first connecting part-unit 10 and the coupling gear and between coupling gear 30 and the second connecting part-unit 20 makes it possible to transfer the rotation of the driving shaft 1 onto the driven shaft 2 with high angular speed precision, with the desired torque transfer.

It must be pointed out here that another essential requirement from the aspect of operation is that the meeting point of the motion piece 14 and the cross-pin 14d of the first connecting part-unit 10 is situated right on the section crossing the connection of the prong 32d situated at the input end 32b of the first torque transfer shaft 32, the first arm 13e and the second arm 13f belonging to the fork 13d of the first motion transfer unit 13 of the first connecting part-unit 10. Furthermore, in accordance with this, the connection point of the motion piece 24 and cross-pin 14d of the second connecting part-unit 20 is situated on the straight line running through the connection of the prong 32e situated at the output end 32c of the first torque transfer shaft 32, the first arm 23e and the second arm 23f belonging to the fork 23d of the first motion transfer unit 23 of the second connecting part-unit 20.

In the case shown in FIG. 1 the rotation is transferred with the help of the driving mechanism according to the following. During rotation the driving shaft 1 forces the output member 11 of the first connecting part-unit 10 to rotate around its own longitudinal axis 1a. The one end 13a of the first motion transfer unit 13 connected to the one-degree-of-freedom connecting element 12 of the output member 11 revolves around the end 1b of the driving shaft 1 in a way that at the same time at its intermediate connecting piece 13b with the help of the prong 13b connected to the one end 13e and the other end 13f of the fork 13d it forces the first torque transfer shaft 32 fitted with bearings in the house 31 to rotate back and forth around the axis of rotation 32a on the one part; on the other part it forces the other end 13c of the first motion transfer unit 13 to perform circular motion similar to the rotation of the output member 11, but not of the same phase. The other end 13c forced to turn around moves the motion piece 14, the external end 14a of which rotates in the same way as the other end 13c, while via the prong 33d the cross-pin 14d connected to its internal end 14b forces the second torque transfer shaft 33 to rotate back and forth around its own axis of rotation 33a.

The first torque transfer shaft 32 and the second torque transfer shaft 33 of coaxial arrangement transfer their rotation performed in different phases to the output end 32c of the first torque transfer shaft 32 and the output end 33c of the second torque transfer shaft 33. With the help of the one end 23e and the other end 23f of the fork the prong 32e situated at the output end 32c of the first torque transfer shaft 32 forwards the rotation to the one end 23a of the first motion transfer unit 23. In the meantime the prong 33e situated at the output end 33c of the second torque transfer shaft 33 transfers its own back-and-forth motion to the cross-pin 24d situated at the internal end 24b of the motion piece 24. At the external end 24a the motion piece 24 transfer the received motion to the other end 23c of the first motion transfer unit 23, which superposes the this motion with the motion coming from the output end 32c of the first torque transfer shaft 32, and from the two partial motions it composes one single motion, which it transfers through the one end 23a of the first motion transfer unit 23 and the one-degree-of-freedom connecting element attached to it onto the input member 21 attached to the end 2b of the driven shaft. Then the input member 21 transfers the rotation received from the one end 23a of the first motion transfer unit 23 onto the driven shaft 2 rotating its end 2b around its longitudinal axis 2a.

The driving mechanism shown in FIG. 2 solves torque transfer maintaining a permanent angular speed partly with a structural arrangement different from the above. In this case the longitudinal axis 1a of the driving shaft 1 and the longitudinal axis 2a of the driven shaft 2 are not completely parallel to each other, they are at a certain angle with respect to each other. In this case too there is a first connecting part-unit 10, a coupling gear 30 and a second connecting part-unit 20 inserted between the driving shaft 1 and the driven shaft. However, it is important that the first connecting part-unit 10, the coupling gear 30 and the second connecting part-unit 20 should be arranged symmetrically with respect to the bisector of the angle created by the longitudinal axis 1a of the driving shaft 1 and the longitudinal axis 2a of the driven shaft.

In this case again the first connecting part-unit 10 contains an output member 11, a one-degree-of-freedom connecting element 12, a first motion transfer unit 13 and a motion piece 14, but here the output member 11 is a simple arm the one end of which is attached to the end 1b of the driving shaft 1, while its other end is equipped with a one-degree-of-freedom connecting element 12, which is a ball-bearing in this case too. The first motion transfer unit 13—unlike in the previous case—is a bent rod element the intermediate connecting piece 13b of which is situated right in the bending. In the case of this construction again the “α” angle created by the sections between the one end 13a and the intermediate connecting piece 13b and between the intermediate connecting piece 13b and the other end 13c is between 0-180°. The one end 13a of the first motion transfer unit 13 is fixed into the one-degree-of-freedom connecting element 12, while the other end 13c is connected to the motion piece 14.

The second connecting part-unit 20 has an input member 21 attached to the end 2b of the driven shaft 2, a one-degree-of-freedom connecting element 22 attached to the disc-like input member 21, a first motion transfer unit 23 the one end 23a of which is connected to the one-degree-of-freedom connecting element 22, and a motion piece 24 connected to the other end 23c of the first motion transfer unit 23. The first motion transfer unit 23—similarly to the first motion transfer unit 13—consists of one single bent rod element with an intermediate connecting piece 23b situated in the bending between the one end 23a and the other end 23c. At the intermediate connecting piece 23b there is a “P” inclination angle created by the straight line touching the one end 23a and the intermediate connecting piece 23b and the straight line touching the other end 23c and the intermediate connecting piece 23b, which angle is between 0-180°, favourably it is of the same value as that of the “a” angle of the first connecting part-unit 10.

In this case again the coupling gear 30 contains the first torque transfer shaft 32 and the house 31. However, a significant difference is that the axis of rotation 32a of the first torque transfer shaft 32 and the axis of rotation 33a of the second torque transfer shaft 33 are parallel to each other. The house 31 of the coupling gear 30 is also different, as in this case the house has a fixed house-member 31a and a swinging house-member 31b. The first torque transfer shaft 32 is fitted with independently in the fixed house-member in a rotating way, while the second torque transfer shaft 33 is taken through the swinging house-member 31b in a rotating way. Apart from the second torque transfer shaft 33 the swinging house-member 31b is also in connection with the first torque transfer shaft 32 so that it is attached to the first torque transfer shaft 32 in a fixed position. In this way the swinging house-member 31b can rotate with respect to the fixed house-member 31a around the axis of rotation 32a of the first torque transfer shaft 32, together with the first torque transfer shaft 32.

The first torque transfer shaft 32 and the second torque transfer shaft 33 are positioned in the house 31 in a way that the straight line touching the input end 32b of the first torque transfer shaft 32 and the input end 33b of the second torque transfer shaft 33 is parallel to the straight line touching the output end 32c of the first torque transfer shaft 32 and the output end 33c of the second torque transfer shaft 33.

When the first connecting part-unit 10 and the coupling gear 30 are connected to each other, the intermediate connecting piece 13b of the first motion transfer unit 13 of the first connecting part-unit 10 is attached to the input end 32b of the first torque transfer shaft 32, while the motion piece 14 is attached to the input end 33b of the second torque transfer shaft 33 by inserting a pin-sleeve joint.

Similarly to the first connecting part-unit 10 the second connecting part-unit 20 is connected to the coupling gear 30 so that the intermediate connecting piece 23b of the first motion transfer unit 23 of the second connecting part-unit 20 is connected to the output end 32c of the first torque transfer shaft 32, while the motion piece 24 is connected to the output end 33c of the second torque transfer shaft 33.

The version of the driving mechanism shown in FIG. 2 operates according to the following. In the course of the rotation of the driving shaft 1 the output member 11 attached to the end 1b of the driving shaft 1 and the one-degree-of-freedom connecting element attached to it revolve together with the driving shaft 1. While the one end 13a of the first motion transfer unit 13 fitted in the one-degree-of-freedom connecting element 12 is also revolving, the rotation of the one end 13a is divided into two essential components by the first motion transfer unit 13 itself. As one of the components practically the intermediate connecting piece 13b of the first motion transfer unit 13 forces the first torque transfer shaft 32 to rotate back and forth around its own axis of rotation 32a. As the other component the other end 13c of the first motion transfer unit 13 also performs a revolving motion, as a result of which the motion piece 14 connected to the other end 13c forces the input end 33b of the second torque transfer shaft 33 and the second torque transfer shaft 33 itself to rotate back and forth around the axis of rotation 33a of the second torque transfer shaft 33.

Furthermore, at the same time the second torque transfer shaft 33 also swings slightly back and forth around the axis of rotation 32a of the first torque transfer shaft 32. It is because the swinging house-member 31b is attached in a fixed position to the first torque transfer shaft 32, so when the first torque transfer shaft 32 is swinging around the axis of rotation 32a the swinging house-member 31b is swinging too, which also swings the second torque transfer shaft 33 that can rotate in the swinging house-member 31b. The swinging of the swinging house-member 31b around the axis of rotation 32a is necessary, because this is how the two motion components of different directions mentioned above, deriving from the rotating motion of the driving shaft 1 can be separated from each other clearly.

The back-and-forth rotation of the first torque transfer shaft 32 of the coupling gear 30 around its own axis of rotation 32a and the second torque transfer shaft 33 of the coupling gear 30 around its own axis of rotation 33a, and the swinging of the second torque transfer shaft 33 around the axis of rotation 32a is transferred via the coupling gear 30 to the structural elements of the second connecting part-unit 20, and finally—as described in connection with FIG. 1—it makes the end 2b of the driven shaft 2 rotate. Due to the first connecting part-unit 10, the coupling gear 30 and the second connecting part-unit 20 the angular speed of the driven shaft 2 is practically the same as the angular speed of the driving shaft 1 without any fluctuations, and the torque generated at the end 1b of the driving shaft 1 also appears at the end 2b of the driven shaft 2.

It must be pointed out here that in the case of the structural arrangement of the first connecting part-unit 10 and the second connecting part-unit 20 shown in FIG. 1 and FIG. 2 the direction of rotation of the driving shaft 1 and the direction of rotation of the driven shaft 2 are contrary to each other. However, in the case that the first motion transfer unit 13 and motion piece 14 of the first connecting part-unit 10 and the first motion transfer unit 23 and motion piece 24 of the second connecting part-unit 20 are not connected in a mirror-symmetric position shown in the figures, but in a different way, for example the first motion transfer unit 13 and the motion piece 14 are projected with a 180° rotation around an imaginary axis of symmetry to determine the position of the second connecting part-unit 20, then the direction of rotation of the end 2b of the driven shaft 2 will be the same as the direction of rotation of the end 1b of the driving shaft 1.

In the case of changing the size of the elements of the first connecting part-unit 10 and the second connecting part-unit 20 in proportion with each other, the extent of the transferred torque can also be changed, but even then the absolute value of the angular speed of the driving shaft 1 and the driven shaft 2 remains the same.

The driving mechanism according to the invention can be used advantageously everywhere where torque needs to be transferred between shafts in different positions while maintaining a constant angular speed.

List of references

| | | |
|---|---|---|
| 1 driving shaft | 1a | longitudinal axis |
| | 1b | end |
| 2 driven shaft | 2a | longitudinal axis |
| | 2b | end |
| 10 first connecting part-unit | 11 | output member |
| | 12 | one-degree-of-freedom |
| | | connecting element |
| | 13 | first motion transfer unit |
| | 13a | one end |
| | 13b | intermediate connection piece |
| | 13c | another end |
| | 13d | fork |
| | 13e | first arm |
| | 13f | second arm |
| | 14 | motion piece |
| | 14a | external end |
| | 14b | internal end |
| | 14c | axis |
| | 14d | cross-pin |
| | 14e | longitudinal axis |
| 20 second connecting part-unit | 21 | input member |
| | 22 | one-degree-of-freedom |
| | | connecting element |
| | 23 | first motion transfer unit |
| | 23a | one end |
| | 23b | intermediate connecting piece |
| | 23c | other end |
| | 23d | fork |
| | 23e | first ann |
| | 23f | second arm |
| | 24 | motion piece |
| | 24a | external end |
| | 24b | internal end |
| | 24c | axis |
| | 24d | cross-pin |
| | 24e | longitudinal axis |
| 30 coupling gear | 31 | house |
| | 31a | fixed house-member |
| | 31b | swinging house-member |
| | 32 | first torque transfer shaft |
| | 32a | axes of rotation |
| | 32b | input end |
| | 32c | output end |
| | 32d | prong |
| | 32e | prong |
| | 33 | second torque transfer shaft |
| | 33a | axes of rotation |
| | 33b | input end |
| | 33c | output end |
| | 33d | prong |
| | 33e | prong |
| _{”}α” angle | | |
| _{”}β” angle | | |

1. Driving mechanism for transferring torque from a driving shaft to a driven shaft, which consists of a first connecting part-unit attached to the driving shaft and a second connection part-unit attached to the driven shaft, and a coupling gear inserted between the first connecting part-unit and the second connecting part-unit, characterised by that the first connecting part-unit (10) contains an output member (11) attached to the driving shaft (1) in a fixed position, a first motion transfer unit (13) connected to the output member (11) via a one-degree-of-freedom connecting element (12) and a motion piece (14) connected to the first motion transfer unit (13) in a rotating way, where there is an intermediate connecting piece (13b) between the one end (13a) of the first motion transfer unit (13) connected to the output member (11) and its other end (13c) connected to the motion piece (14), and the section between the one end (13a) of the first motion transfer unit (13) and the intermediate connecting piece (13b), and the section between the other end (13c) of the first motion transfer unit (13) and the intermediate connecting piece (13b) are at an angle (α) of 0-180° with respect to each other, while the second connecting part-unit (20) contains an input member (21) attached to the driven shaft (2) in a fixed position, a first motion transfer unit (23) attached to the input member (21) via a one-degree-of-freedom connecting element (22) and a motion piece (24) connected to the first motion transfer unit (23) in a rotating way, where there is an intermediate connecting piece (23b) between the one end (23a) of the first motion transfer unit (23) connected to the input member (21) and its other end (23c) connected to the motion piece (24), and the section between the one end (23a) of the first motion transfer unit (23) and the intermediate connecting piece (23b), and the section between the other end (23c) of the first motion transfer unit (23) and the intermediate connecting piece (23b) are at an angle (β) of 0-180° with respect to each other, the coupling gear (30) has a first torque transfer shaft (32) and a second torque transfer shaft (33) embedded in a house (31) in a rotating way, the first torque transfer shaft (32) has an input end (32b) and an output end (32c), while the second torque transfer shaft (33) has an input end (33b) and an output end (33c), the input end (32b) of the first torque transfer shaft (32) is connected to the intermediate connecting piece (13b) of the first motion transfer unit (13) of the first connecting part-unit (10), and its output end (32c) is connected to the intermediate connecting piece (23b) of the first motion transfer unit (23) of the second connecting part-unit (20) allowing torque transfer, but in a self-adjusting way, while the input end (33b) of the second torque transfer shaft (33) is connected to the motion piece (14) of the first motion transfer unit (13) of the first connecting part-unit (10), and its output end (32c) is connected to the motion piece (14) of the first motion transfer unit (23) of the second connecting part-unit (20) allowing torque transfer, but in a self-adjusting way.

2-8. (canceled)
